(19) United States
(12) Patent Application Publication
(10) Pub. No.: US 2010/0320714 A1
(43) Pub. Date: Dec. 23, 2010

(54) RETRACTABLE VEHICLE STEP

(75) Inventors: Nicholas WEBB, Chipping Norton (GB); Robert MORGAN, Banbury (GB); Stewart OXLEY, Derby (GB)

Correspondence Address: CHERNOFF, VILHAUER, MCCLUNG & STENZEL, LLP, 601 SW Second Avenue, Suite 1600, PORTLAND, OR, 97204-3157, US

(73) Assignee: ASG Group Ltd, Derby (GB)

(21) Appl. No.: 12/750,412

(22) Filed: Mar. 30, 2010

(30) Foreign Application Priority Data
Apr. 3, 2009 (GB) 0905816.5

(51) Int. Cl. B60R 3/02

(52) U.S. Cl. 280/166

(57) ABSTRACT

A retractable step assembly 10, 51, 60 for a vehicle. The assembly 10, 51, 60 comprises a step member 24, and a connection arrangement of variable length extendible from the step member 24 to a mounting 50 on the vehicle. The assembly 10 is configured such that operation thereof causes the connection arrangement to selectively increase or decrease in length. At a minimum length of the connection arrangement the step 24 is retracted, and at a maximum length of the connection arrangement the step 24 is in an in use position.

### CROSS-REFERENCE TO RELATED APPLICATION

This application claims benefit of United Kingdom Application No. GB 0905816.5 filed Apr. 3, 2009, the entire disclosure of which is hereby incorporated herein by reference for all purposes.

### BACKGROUND OF THE INVENTION

This invention relates to retractable step assemblies for vehicles.

With taller vehicles such as for instance SUVs, it is often desirable to provide a step to aid a person getting in and out of the vehicle. It is often required that such steps retract beneath the vehicle prior to driving thereof, and particularly that they do not extend laterally outwards beyond the remainder of the vehicle during motion.

### SUMMARY OF THE INVENTION

According to the present invention there is provided a retractable step assembly for a vehicle, the assembly comprising a step member, a connection arrangement of variable length extendible from the step member to a mounting on the vehicle, the assembly being configured such that operation thereof causes the connection arrangement to selectively increase or decrease in length, and at a minimum length of the connection arrangement the step is retracted, and at a maximum length of the connection arrangement the step is in an in use position.

The step member may be hollow, and a substantial part of the connection arrangement may locate within the step member at least at a minimum length thereof.

The connection arrangement may include first and second elongate members in a telescopic configuration with a one of the first or second elongate members extendible into the other, such that at a minimum length of the connection arrangement a substantial part of the first or second elongate member locates within the other, and at a maximum length a substantial part of the one elongate member extends from the other elongate member.

The assembly may be configured such that as the step member moves to an in use position it also moves downwardly.

The step member may be connectable to a vehicle by a first pivoted linkage. The assembly may be configured such that when the step member is in an in use position, the first pivoted linkage extends downwardly, and may extend substantially vertically downwards.

The mounting of the connection arrangement to a vehicle may be in the form of a second pivoted linkage. The second pivoted linkage may be shorter than the first pivoted linkage, may be significantly shorter, and may be between two and eight times shorter.

A plurality of spaced connection arrangements may be provided along the length of the step member.

In one form of the invention the first elongate member is rotatable and is threadably engageable with the second elongate member such that rotation of the first elongate member in one direction causes the first and second elongate members to move together towards the minimum length, and rotation in the other direction causes moving apart towards the maximum length.

The assembly may include a motor to rotate the first elongate member and thus vary the length of the connection arrangement. The motor may be located in the step.

In one embodiment a motor is provided for each connection arrangement.

In a second embodiment a drive is provided between the motor and each connection arrangement.

In a further form of the invention the first and second elongate members have a piston and cylinder configuration, with one elongate member constituting the piston which slidably locates in the other elongate member as the cylinder.

A hydraulic or pneumatic pump may be connected to the cylinder to move the piston. A pump may be provided for each connection arrangement, or a single pump may power a plurality of connection arrangements, and may power connection arrangements on a plurality of step assemblies on a vehicle.

The pump or pumps may be located in the step, or alternatively elsewhere on a vehicle.

The pump or pumps may be in the form of a combined pump and reservoir unit.

### BRIEF DESCRIPTION OF THE DRAWINGS

For a better understanding of the invention, and to show how the same may be carried into effect, reference will now be made, by way of example, to the accompanying drawings, in which:

FIG. 1 is a diagrammatic cross sectional view of a first step assembly according to the invention in a retracted condition;

FIG. 2 is a similar view to FIG. 1 but in an in use condition;

FIG. 3 is a diagrammatic perspective view of a second step assembly in an in use condition;

FIG. 4 is a diagrammatic perspective side view of the assembly of FIG. 3 in a retracted condition;

FIGS. 5 and 6 are respectively diagrammatic cross sectional side views of the assembly of FIG. 3 in respectively a retracted and in use condition; and

FIGS. 7 and 8 are similar views respectively to FIGS. 1 and 2 but of a third step assembly according to the invention.

### DETAILED DESCRIPTION

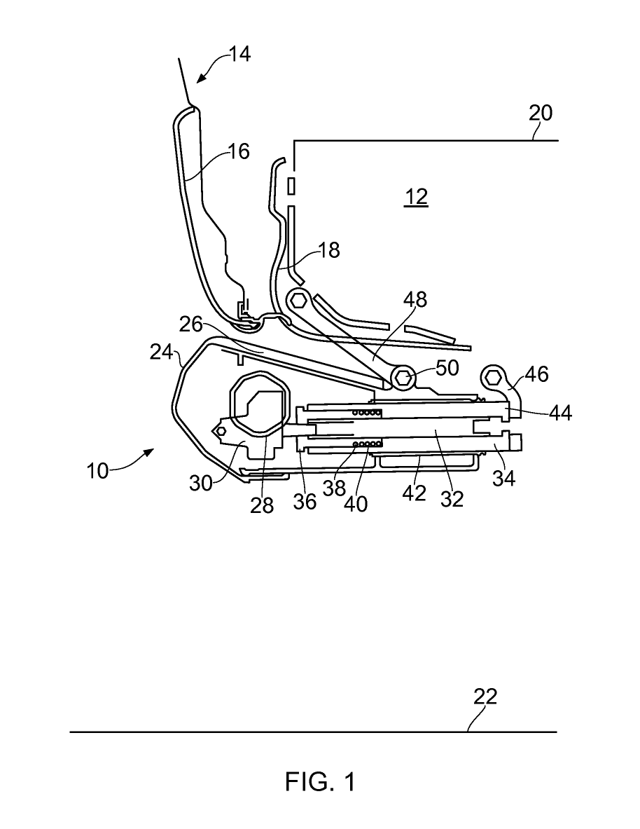

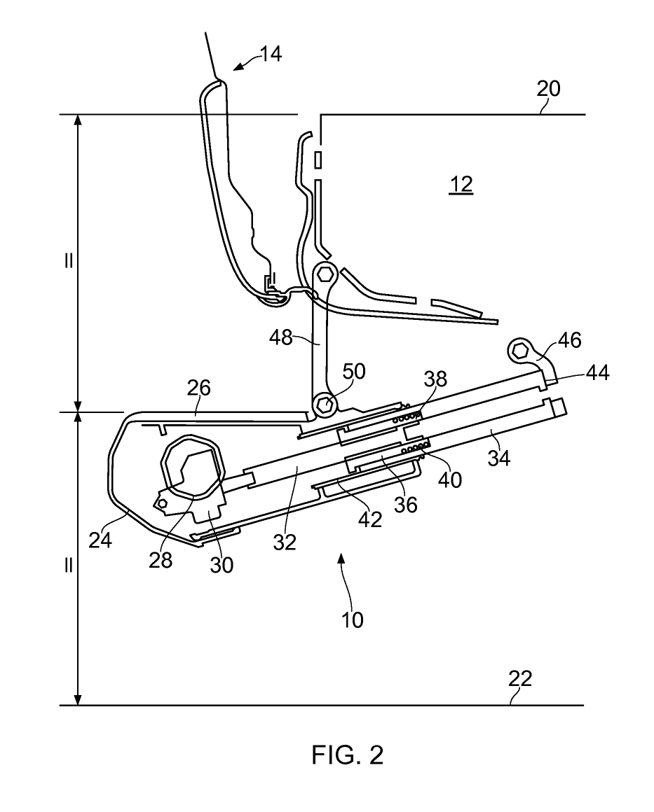

FIGS. 1 and 2 show a first retractable step assembly 10 mounted on a vehicle 12, only part of which is shown, such as an SUV. The vehicle 12 is shown with a door 14 with a lower cladding 16. The sill is shown with a cover moulding 18. The interior floor of the vehicle is shown at 20, and the ground is indicated at 22.

The assembly 10 includes a hollow step member 24 with a plate 26 on a top surface thereof. The step member 24 is connected to the vehicle 12 at three spaced locations, including two outer locations and a central location, with one of the outer locations shown in the drawings.

The two outer locations include a motor 28 located within the hollow step member 24 and connected to a gearbox 30. A threaded bar 32 extends from the gearbox 30 and points inwardly towards the vehicle 12. A tubular member 34 locates around the threaded bar 32, and is threadably connected thereto by a trapped nut 36 at the outer end of the tubular member 34. The nut 36 locates in a cylindrical recess 38 in the outer end of the tubular member 34, and a damper spring 40 extends between the inner end of the recess 38 and the nut 36.

The tubular member 34 slidably extends through an inner part 42 of the step. The inner end 44 of the tubular member mounts an inner pivotal linkage 46 to the vehicle 12. A longer outer pivotal linkage 48 extends downwardly from the vehicle to a mounting 50, located on top of an outer end of the inner part 42 of the step member 24, and mounted to the step member 24.

In use in a retracted condition as shown in FIG. 1, the threaded bar 32 is located substantially wholly within the tubular member 34. The assembly 10 locates immediately beneath the vehicle 12 with the outer side of the step member 24 not extending beyond an outermost part of the door 14. When the step assembly 10 is to be deployed, which may be automatically actuated upon the door 14 being opened or pressing of a key fob, each motor 28 is actuated causing rotation of the threaded bar 32 which causes the tubular member 34 to move inwardly relative to the vehicle 12.

By virtue of the engagement of the inner end 44 of the tubular member 34 with the inner pivotal linkage 46, the step member 24 is urged outwardly. As a result of the longer outer pivotal linkage 48 the step member 24 is also urged downwardly to the position shown in FIG. 2 with the outer pivotal linkage 48 extending substantially vertically downwardly, and the plate 26 extending substantially horizontally.

In the position shown in FIG. 2 the plate 26 is at a correct horizontal orientation for a person getting into or out of the vehicle 12. Also as shown, the top of the plate 26 is at substantially half the distance between the ground 22 and the vehicle interior floor 20. As the outer pivotal linkage 48 extends substantially, vertically, downward forces on the plate 26 are urged directly downwardly through the outer pivotal linkage 48. The step member 24 is retracted by the motor 28 driving the threaded bar 32 in the opposite direction, which may be automatically actuated upon the door 14 being closed.

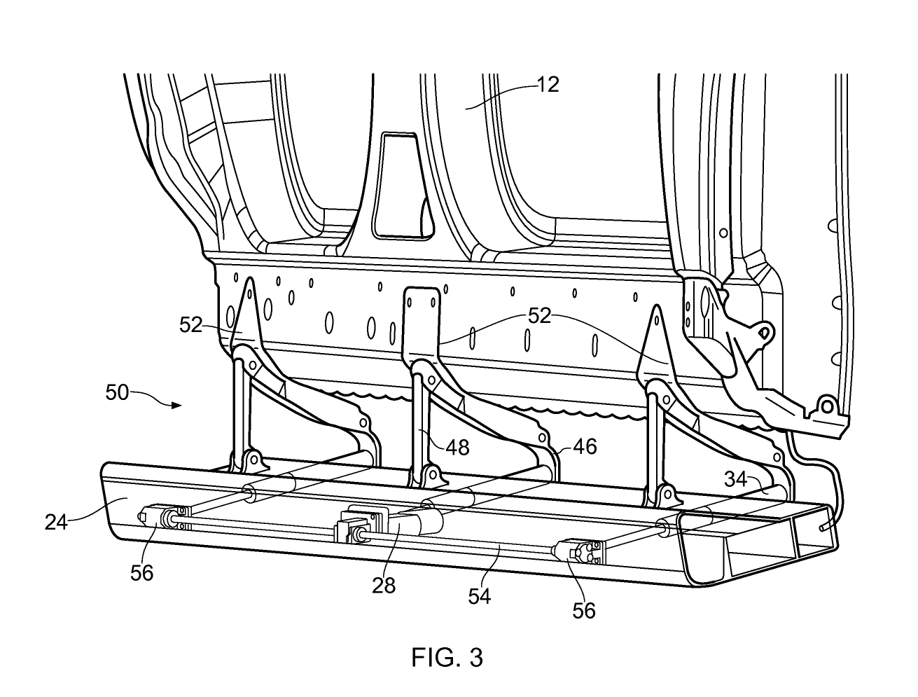

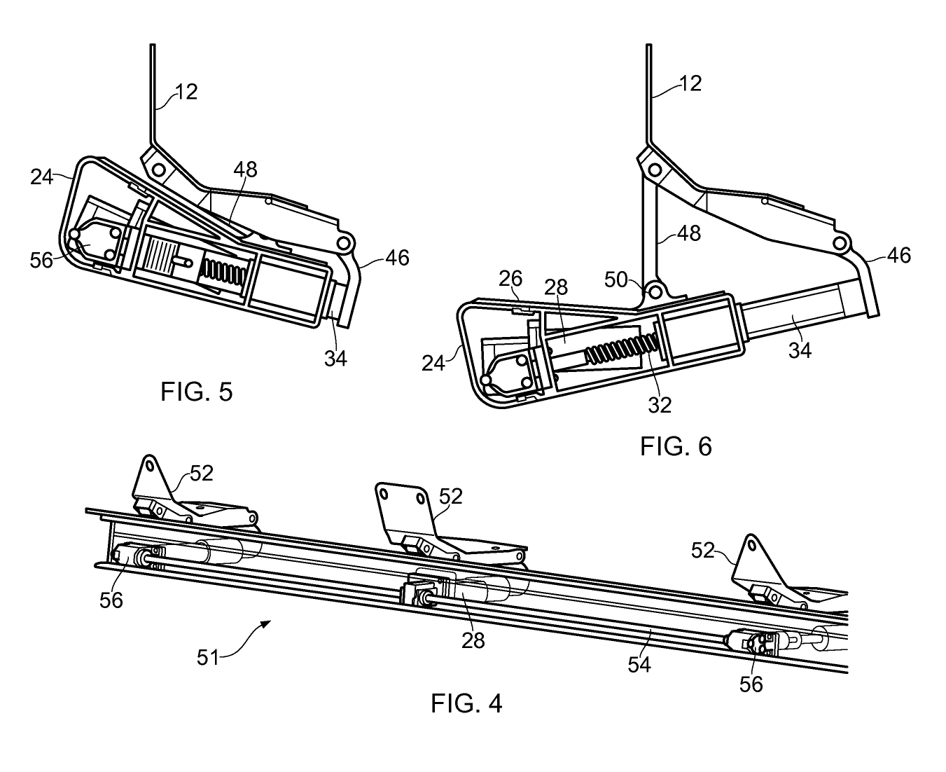

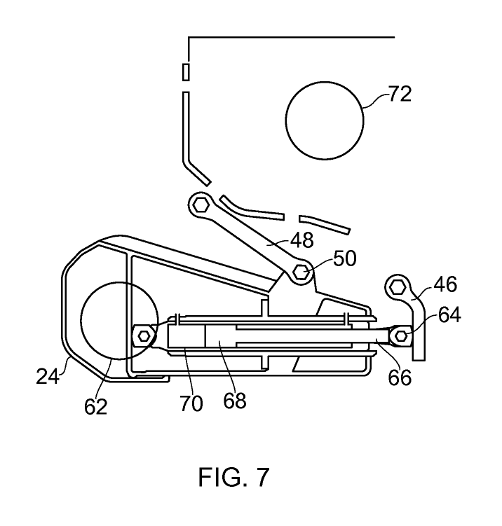

FIGS. 3 to 6 shows a second assembly 51 which operates in a similar manner to the assembly 10, and only the differences therein will be described. Similar reference numerals are used for similar components. In this instance, a single motor 28 is provided adjacent the central connection 52. The motor 28 connects to the threaded bars 32 via a driven shaft 54 extending through the length of the step member 24 and engaging with gearboxes 56 at the connections at each end of the step member 24.

There are thus described retractable step assemblies for vehicles where the motor or motors and part or all of other components are located wholly within a hollow step member. This therefore provides significant protection for these components from the elements. This also provides a very neat and compact arrangement. By varying the linkages and potentially the angle of the plate on the step member, the same or similar components and arrangements could be used in a wide range of vehicles.

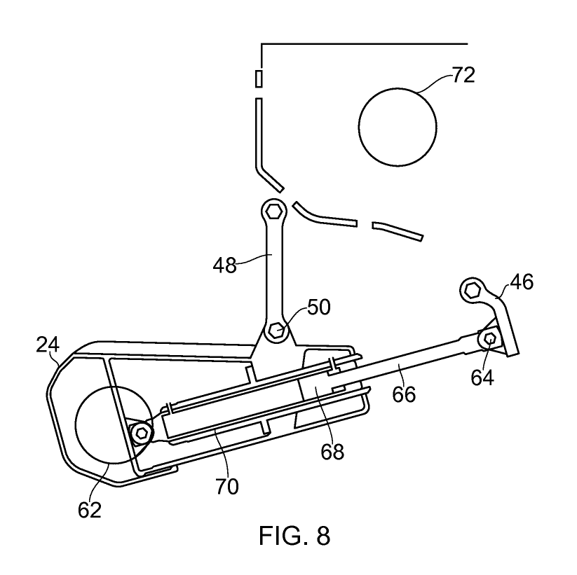

FIGS. 7 and 8 show a third retractable step assembly 60 which is similar in most respects to the assembly 10 except that the assembly 60 is controlled by a pump 62. In this instance the pivotal linkage 46 pivotally mounts one end 64 of a piston member 66. The other end 68 of the piston member 66 locates in a cylinder 70. The mounting 50 is provided on one side of the cylinder 70.

In use, the pump 62 pumps or sucks hydraulic or pneumatic fluid into the cylinder 70 to move the piston 66 and hence increase or decrease the combined length of the piston 66 and cylinder 70. The assembly 60 will therefore operate in a similar manner to the assembly 10.

In the drawings the pump 62 is shown within the step 24. The pump could though be located elsewhere on the vehicle as shown at 72 in the drawings. A single pump 62 could power one piston and cylinder configuration, or could power all of the piston cylinder configurations in a step, and perhaps power piston and cylinder configurations in more than step on a vehicle.

Various other modifications may be made without departing from the scope of the invention. For instance a different arrangement of linkages may be used. A different number of connections between the step member and the vehicle may be included. A different connection may be provided between the motor and the threaded member. A different arrangement could be provided to produce a variable length member.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A retractable step assembly for a vehicle, the assembly comprising a step member, a connection arrangement of variable length extendible from the step member to a mounting on the vehicle, the assembly being configured such that operation thereof causes the connection arrangement to selectively increase or decrease in length, and at a minimum length of the connection arrangement the step is retracted, and at a maximum length of the connection arrangement the step is in an in use position.

2. An assembly according to claim 1, in which the step member is hollow, and a substantial part of the connection arrangement may locate within the step member at least at a minimum length thereof.

3. An assembly according to claim 1, in which the connection arrangement includes first and second elongate members in a telescopic configuration with a one of the first or second elongate members extendible into the other, such that at a minimum length of the connection arrangement a substantial part of the first or second elongate member locates within the other, and at a maximum length a substantial part of the one elongate member extends from the other elongate member.

4. An assembly according to claim 1, in which the assembly is configured such that as the step member moves to an in use position it also moves downwardly.

5. An assembly according to claim 1, in which the step member is connectable to a vehicle by a first pivoted linkage.

6. An assembly according to claim 5, in which the assembly is configured such that when the step member is in an in use position, the first pivoted linkage extends downwardly, and may extend substantially vertically downwards.

7. An assembly according to claim 5, in which the mounting of the connection arrangement to a vehicle is in the form of a second pivoted linkage.

8. An assembly according to claim 7, in which the second pivoted linkage is shorter than the first pivoted linkage, and may be significantly shorter, and may be between two and eight times shorter.

9. An assembly according to claim 1, in which a plurality of spaced connection arrangements are provided along the length of the step member.

10. An assembly according to claim 3, in which the first elongate member is rotatable and is threadably engageable with the second elongate member such that rotation of the first elongate member in one direction causes the first and second elongate members to move together towards the minimum length, and rotation in the other direction causes moving apart towards the maximum length.

11. An assembly according to claim 10, in which the assembly includes a motor to rotate the first elongate member and thus vary the length of the connection arrangement.

12. An assembly according to claim 11, in which the motor is located in the step.

13. An assembly according to claim 11, in which a motor may be provided for each connection arrangement, or a drive may be provided between the motor and each connection arrangement.

14. An assembly according to claim 3 in which the first and second elongate members have a piston and cylinder configuration, with an elongate member constituting the piston which slideably locates in the other elongate member as the cylinder.

15. An assembly according to claim 14, in which a hydraulic or pneumatic pump is connected to the cylinder to move the piston.

16. An assembly according to claim 15, in which a pump is provided for each connection arrangement, or a single pump powers a plurality of connection arrangements.

17. An assembly according to claim 16, in which a single pump powers connection arrangements on a plurality of step assemblies on a vehicle.

18. An assembly according to claim 15, in which the pump or pumps are located in the step.

19. An assembly according to claim 15, in which the pump or pumps is located elsewhere on a vehicle to the step.

20. An assembly according to claim 15, in which the pump or pumps are in the form of a combined pump and reservoir unit.
